(19) United States
(12) Patent Application Publication
(10) Pub. No.: US 2016/0362759 A1
(43) Pub. Date: Dec. 15, 2016

(54) METHOD FOR PRODUCING HOT-ROLLED SEAMLESS PIPES FROM TRANSFORMABLE STEEL, IN PARTICULAR FOR PIPELINES FOR DEEP-WATER APPLICATIONS, AND CORRESPONDING PIPES

(71) Applicant: VALLOUREC DEUTSCHLAND GMBH, Düsseldorf (DE)

(72) Inventors: Tanja Schmidt, Düsseldorf (DE); Ferid Gercekoglu, Erkrath (DE)

(21) Appl. No.: 15/121,271

(22) PCT Filed: Feb. 23, 2015
(86) PCT No.: PCT/EP2015/053707

§ 371 Date: Aug. 24, 2016

(30) Foreign Application Priority Data
Feb. 25, 2014 (DE) 10 2014 102 452.4

(51) Int. Cl. C21D 9/08; C22C 38/26; C22C 38/24; C22C 38/06; C22C 38/04; F16L 9/02; C22C 38/00; C21D 8/10; C21D 1/18; C21D 1/613; B23K 31/02; F16L 13/02; C22C 38/28; C22C 38/02

(52) U.S. Cl. CPC C21D 9/085; C22C 38/28; C22C 38/26; C22C 38/24; C22C 38/06; C22C 38/04; C22C 38/02; C22C 38/002; C22C 38/001; C21D 8/105; C21D 1/18; C21D 1/613; B23K 31/027; F16L 13/02; F16L 9/02

(57) ABSTRACT

A method for producing hot-rolled seamless pipes from transformable steel for pipelines in which the pipe ends are hot-upsetted in order to achieve a thickened wall portion after a final rolling process of the pipes to provide pipes with excellent fatigue, corrosion, and welding properties. A pre-selected ratio between a wall thickness of the pipe end and a wall thickness of a wall body adjoining the pipe end is set by the hot-upsetting process such that a pipe is achieved with a pipe end which has a lower strength than the pipe body after a uniform tempering process of the entire pipe following the hot-upsetting process by using a previously ascertained wall thickness-dependent cooling rate during the tempering process.

### CROSS REFERENCE TO RELATED APPLICATION

The present application claims the priority benefits of International Patent Application No. PCT/EP2015/053707, filed Feb. 23, 2015, and claims benefit of DE 102014102452.4, filed on Feb. 25, 2014, which are hereby incorporated herein by reference in their entireties.

### BACKGROUND AND FIELD OF THE INVENTION

The invention relates to a method for producing hot-rolled, seamless pipes from transformable steel, in particular for pipelines for deep-water applications, in which the pipe ends are hot-upsetted after a final rolling process of the pipes in order to achieve a thickened wall portion.

The invention also relates to a seamless pipe from transformable steel having a minimum yield point of 415 MPa, which is produced by hot-rolling, followed by hot-upsetting of the pipe ends for producing a thickened wall portion and a subsequent uniform hardening and tempering treatment of the entire pipe and a subsequent mechanical processing step of the thickened pipe ends.

In particular, the invention relates to pipes which are produced according to the above mentioned method and which are welded together at their pipe ends in order to produce pipelines.

It is generally known to use pipelines where individual pipes are welded together by a joint seam to give an endless string as offshore lines in the deep-water area in order to convey oil and gas. Such pipelines and the welded joints thereof are in this case exposed to diverse loads when they are laid and used. The pipe dimensions used for this purpose reach up to 508 mm for the outside diameter and up to 80 mm for the wall thickness. For example, an outside pipe diameter of 273.1 mm and a wall thickness of 28.4 mm are typical.

The individual pipes are usually welded together on a lay barge or onshore into an endless pipe and then laid on the floor of the ocean. When laid e.g. according to the S-lay or i-lay method, the pipes and the welded joints are exposed to very high mechanical loads resulting from bending and, following laying, to a very high hydrostatic pressure at low water temperatures reaching to as low as 4° C., depending on the depth of the ocean.

In use, the pipeline is additionally subjected to stress e.g. dynamically by ocean currents and by a high temperature of the media of up to 220° C., by a high pressure of the medium to be conveyed of up to 150 MPa and/or by a high corrosiveness of the acidic medium to be transported, such as carbonic acid, hydrogen sulfide or oxygen.

In order to be able to realize an economical laying, it must be possible for the individual pipes on the lay barge or onshore to be welded together into an endless string in automated fashion. It must also be possible to carry out manual repair welding operations without major effort.

Therefore, when the pipe connection is produced, an accurately matching geometry of the pipe ends which are to be welded together and have tight tolerances is an absolute precondition in order to achieve a high fatigue strength of the welded joint when the pipeline is in use. In order to avoid geometric notches, attention must be paid in particular to the fact that there is no edge displacement of the pipe ends to be welded together.

The accurate geometry and tight tolerances of the pipe ends to be welded together are not only important for complying with the high demands made on the fatigue strength but also for the time required for producing the welded joints and thus for the production costs of the pipeline. Only with an accurate alignment of the pipe ends to be welded together in tight tolerances can the welded joint be produced in cost-effective and efficient manner, e.g. by automated welding, and a high fatigue strength of the welded joint can be ensured. An undisturbed flow of media through the pipeline is also only ensured and contributes to efficiently achieving the aspired delivery rate of the pipeline.

However, due to manufacturing, the tolerances of industrially hot-rolled, seamless pipes cannot be kept safely within tight tolerances required for a highly efficient production of the joint welding step. In addition, the pipe diameter is subject to minor fluctuations in wall thickness and ovalities. Due to this, it is necessary to select and assign the pipe ends to be welded together in accordance with their geometry. Therefore, a corresponding measurement of the pipe ends has formerly been indispensable for this directed assignment.

In order to avoid a complicated measurement, selection and assignment of the pipes and to observe the technological demands made on the pipe connections, patent specification EP 2 170 540 B1 discloses a method for producing hot-finished seamless pipes by means of which pipes having optimized fatigues properties in the welded state can be produced and additionally can be welded together without a specific selection and assignment in automated fashion on a lay barge or onshore.

In this known method, the wall thickness which is produced in a first step on the particular pipe end in a portion thereof is greater than that of the other parts of the pipe body, the thickened wall portion of the particular pipe end region being produced by upsetting the pipe end, the transitions to the pipe body, which are produced during the upsetting process on the outer circumference and inner circumference, being displaced, based on the longitudinal pipe axis, and in a second step, the demanded pipe cross-section being produced in this region by mechanical processing and the transition from the processed to the unprocessed region of the pipe being provided without any shoulder with a large radius or with combinations of radii so as to obtain a smooth and notch-free transition and to provide the finished contour in the originally thickened end region of the pipe with an outside diameter which corresponds to the original diameter of the pipe.

Similar methods where an accurate fit of the pipe ends are produced by hot-upsetting and mechanical processing are also known from laid-open print DE 10 2004 059 091 A1 and patent specification EP 0 756 682 B1, for example.

Patent specification DE 3445371 C2 discloses the use of a hardening and tempering treatment to hot-rolled, seamless pipes made from transformable steel for the oil and gas industry with pipe ends thickened by upsetting. The thickened pipe ends are provided by welding with threaded connectors for producing drill pipes that can be screwed together. The hardening and tempering step shall serve to take into account the high loads when such pipes are used. After the hardening and tempering treatment, the thus produced drill pipe has a hardness and strength which is uniform length-wise, thus improving in particular the corrosion-mechanical load capacity.

However, it has turned out that pipelines produced by means of these known methods do not yet meet the demands made on the use in deep-water areas.

When laying pipelines, the oil and gas industry currently encounters the following obstacles, in particular in deep-water areas:

In the case of standard steels which usually have good welding characteristics and a strength class of up to 450 MPa, the strength must be compensated in the form of an extreme wall thickness increase in relation to the water depth of up to 5000 m, as a result of which the pipe string becomes too heavy for laying.

The use of steel pipes made from high-strength grades with strengths of over 600 MPa, such as an X80 according to API 5L, is still limited since the weldability is not ensured sufficiently under the given circumstances. Investigations have shown that with these high-strength grades it is not yet possible to reliably achieve the required mechanical properties of the welded joint at the thickened pipe ends in the hardened and tempered state since due to the high strengths these steels have a tendency towards increased hardness, crack formation and increased corrosion susceptibility, in particular in the welded seam on the thickened pipe end, in particular when acid gas is used.

### SUMMARY OF THE INVENTION

The object of the invention is to provide a method for producing hot-rolled, seamless pipes from transformable steel, in particular for pipelines for deep-water applications, said pipes having excellent fatigue, corrosion and welding properties. In connection with deep-water applications, excellent laying properties are also necessary in order to comply with the complex offshore requirements also in the case of great water depths of up to 5000 m and still being producible efficiently. The pipes shall be producible in cost-effective manner, consist of a high-strength material, have a high fatigue strength and a good weldability and it shall be possible to weld them together and lay them in automated fashion.

According to an aspect of the invention, a method for producing hot-rolled, seamless pipes from transformable steel, in particular for pipelines for deep-water applications, in which the pipe ends are hot-upsetted in order to achieve a thickened wall portion after the final rolling process of the pipes, serves to achieve excellent fatigue, corrosion and welding properties by adjusting a pre-selected ratio between a wall thickness of the pipe end and a wall thickness of a wall body adjoining the pipe end by the hot-upsetting process so as to achieve, after a uniform hardening and tempering treatment of the entire pipe after the hot-upsetting process by means of a previously determined wall thickness-dependent cooling rate during the hardening and tempering process, a pipe having a pipe end which has a lower strength than the pipe body.

In connection with the present invention, deep-water area refers to water depths ranging from 1000 m to 5000 m, preferably up to 4000 m.

According to an aspect of the invention, after the final upsetting step the thus produced pipe is subjected to a uniform hardening and tempering treatment, in which on the basis of previously determined wall thickness-dependent cooling rates the hardening and tempering parameters are set in such a way that the upsetted pipe ends are produced with a lower strength than the intermediate pipe body so as to have better welding characteristics.

It is advantageous that, after the uniform hardening and tempering treatment of the entire pipe, a pipe is achieved after the hot-upsetting process with a pipe end which has a lower strength and also a lower hardness and a greater toughness than the pipe body.

Following the hardening and tempering treatment, the pipes are then mechanically processed to the required final dimensions in accordance with the customer specification.

The hardening and tempering treatment is usually composed of a series of heating, quenching and tempering steps, the pipe being heated during the heating step to a temperature above the austenitizing temperature.

The gist of the proposed, formerly unusual hardening and tempering method consists in hardening and tempering the entire pipe after the upsetting process and in adjusting the hardening and tempering parameters on the basis of the ratio between the wall thickness of the pipe ends after the final upsetting process and the intermediate pipe body in such a way that in the subsequent hardening and tempering process a high material strength and, at the two upsetted pipe ends which have a markedly greater wall thickness, a lower strength with excellent welding, fatigue and mechanical properties are produced on account of the adjusting, different wall thickness-related cooling speeds/rates on the pipe body with the initial wall thickness due to the different martensite formation during quenching.

According to an aspect of the invention, the hardening and tempering treatment is carried out in such a way that after the heating to the austenitizing temperature the thickened pipe ends cool down at a markedly slower rate compared to the intermediate pipe body in the subsequent hardening step by quenching, preferably in water, and thus have a markedly lower strength after the tempering step due to the lower martensite content in the structure, which has a very favorable effect on the weldability of the pipe ends since the tendency for cold crack formation during welding is considerably reduced.

Due to the hardening and tempering process in which the entire pipe is subjected to a uniform heat treatment, a continuous and smooth transition of the structure between pipe ends and pipe body is additionally achieved in an advantageous manner. This has a favorable effect on the state of stress and thus on the fatigue strength of the pipe and/or the pipeline. Then, the thus produced and hardened and tempered pipe is finished to the required final dimensions.

For example, if a high-strength material of API grade X80 is used for the production of the seamless pipe, the pipe ends produced in the method according to the invention have a lower strength, e.g. having a grade of X65, while the intermediate pipe body still has a strength of X80, as a result of which the deep-water requirements are fully complied with by means of a comparatively thin-walled and high-strength pipe body and thick-walled low-strength and well weldable pipe ends.

All in all, this serves to produce lighter pipes for laying in deep-water areas and to ensure a very good weldability of the pipe ends as a result of the markedly lower strength of the material at the pipe ends in comparison to the pipe body after the hardening and tempering process.

When the upsetting at the pipe ends becomes too low, this means that the cooling rate during the hardening and tempering step is excessively high and thus the hardness and strength are too high for a good weldability. However, if the wall thickness is upsetted in such a way that it becomes excessively thick as compared to the pipe body, a through-hardening of the pipe ends and thus the minimum requirement made on the mechanical properties is not achieved across the cross-section of the pipe wall.

At least 1.1 times, 1.2 times or 1.3 times the wall thickness in relation to the wall thickness of the pipe body is produced by the hot-upsetting step at the pipe end. At least two times the wall thickness in relation to the wall thickness of the pipe body is produced in a particularly advantageous way by the upsetting step at the pipe end.

In order to comply with the demands made on the properties of the pipes which are to be welded together into a pipeline at a later date, a corresponding thickened wall portion is therefore left on the pipe ends after the mechanical processing step, depending on the requirement in order to achieve the cross sectional area required to receive the laying and operational loads and the stress reduction areas in the transitional region and the lowered mechanical parameters at the pipe end.

The hardening and tempering parameters which are to be adjusted concretely are determined on the basis of cooling rates which are determined beforehand on different wall thicknesses depending on the ratio between the wall thickness of the pipe ends and the wall thickness of the intermediate pipe body and the mechanical material properties to be achieved, the cooling rate during quenching of the pipe being adjusted in such a way that a strength which is markedly lower than at the pipe body adjusts at the pipe ends due to a lower martensite quantity in the structure while the minimum requirements made on the strength of the finished product are still met.

This leads to an excellent weldability of the pipe ends, the lower strength being compensated by a sufficiently large cross sectional area of the pipe ends in order to receive correspondingly large forces while laying the pipeline and in use. However, the pipe body which is disposed between the thickened pipe ends and has a smaller wall thickness experiences a cooling rate which is so high that e.g. the mechanical properties demanded e.g. for an X80 are adjusted.

By means of the method according to the invention it is possible to achieve properties at the pipe as shown in exemplified fashion by means of an X80 in the following table.

| Pipe portion | | pipe end | pipe body |
|---|---|---|---|
| Employed material | | X80 | X80 |
| Achieved grade API | | X65 | X80 |
| Notch impact values | −40° C. | min. individual | min. individual |
| in the transverse | | value 160 Joule | value 160 Joule |
| direction | | | |
| Shear surface | RT | min. 85% | min 85% |
| Yield point | RT | 450-570 MPa | 555-670 MPa |
| Tensile strength | RT | 535-655 MPa | 625-745 MPa |
| YS/TS | RT | 0.85-0.89 | 0.85-0.89 |
| stretching | RT | min. 24.5% | min. 24.5% |
| CTOD | −20° C. | min. 0.9 mm | min. 0.9 mm |
| Hardness | RT | max. 230 HV10 | max. 250 HV10 |
| | | (mean value API) | (mean value API) |

As regards the production of the pipes according to the method of the invention, a material having a depth-desulfurized alloying concept should be used on the basis of a low carbon content and microalloying elements, as a result of which excellent mechanical and corrosion-resistant properties of the entire pipe and an excellent weldability can be achieved at the pipe ends.

A steel having the following alloying composition in % by weight is advantageously used as a transformable material:

C: max. 0.18

Si: max. 0.45

Mn: max. 1.85

P: max. 0.02

S: max. 0.015

N: max. 0.012

Cr: max. 0.30

Cu: max. 0.50

Ti: max. 0.04

As: max. 0.030

Sn: max. 0.020

Nb+V+Ti: max. 0.15%

Mo: max. 0.50%

Ni: max. 0.50%

Pcm: max. 0.22% for C contents of less than or equal to 0.12% with

Pcm=C+Si/30 +(Mn+Cu+Cr)/20 +Ni/60 +Mo/15 +V/10 +5 B and

CE: max. 0.47 for C contents above 0.12% and

CE: max. 0.22 for C contents of up to 0.12% with

CE=C+Mn/6 +(Cr+Mo+V)/5+(Cu+Ni)/15

the remainder being iron including unavoidable steel accompanying elements.

A low carbon content of at most 0.18% and a CE carbon equivalent according to IIW formula of at most 0.47% for C contents above 0.12% and a Pcm value of at most 0.22% for C contents of less than or equal to 0.12%, result in an end product which has an excellent weldability with minor tendency to cold cracks.

Depending on the strength class of the material, the following CE and/or Pcm values should be observed in an advantageous manner:

Minimum yield points from

415 to 485 MPa: Pcm max. 0.21 and CE max. 0.38

485 to 555 MPa: Pcm max. 0.22 and CE max. 0.47

625 to 690 MPa: Pcm max. 0.25 and CE max. 0.53

By the additions of copper, nickel and molybdenum, the steel achieves, due to the mixed crystal and deposition formation, the grade X80 according to API 5L with corresponding excellent strength and low temperature properties of over 150 Joules notched impact energy at a temperature of −60° C. In addition, the through hardening and tempering is ensured across the entire pipe cross-section, also of the thickened pipe ends.

Furthermore, the microalloying elements niobium and/or vanadium and/or titanium can be added by alloying to the steel in contents of up Nb max. 0.09% by weight, V max. 0.11% by weight and Ti max. 0.04% by weight in each case in order to increase the strength and toughness by fine grain formation.

Therefore, it is possible to comply with the very high deep water requirements and an excellent weldability of the pipe ends with only one material and a hardening and tempering treatment adapted to the wall thickness of pipe ends and the pipe body.

In order to safely achieve the requirements made on the mechanical properties and corrosion resistance, the alloying composition should therefore be made in a particularly favorable fashion by way of example as follows (% by weight):

C: 0.05 to 0.12

Si: 0.20 to 0.40

Mn: 1.35 to 1.75

P: max. 0.015

S: mx. 0.003

N: max. 0.007

Cr: max. 0.10

Al: 0.020 to 0.040

Mo: 0.08 to 0.35

Ni: 0.15 to 0.35

Cu: 0.15 to 0.25

Nb: 0.02 to 0.08

V: 0.05 to 0.08 with

Pcrn max. 0.21

the remainder being iron, including unavoidable steel-accompanying elements.

A limitation of chromium to max. 0.100% by weight additionally reduces the susceptibility of hot cracks in the heat-affected zones when welding together the pipe ends, thus contributing to a good weldability in addition to a lower strength and hardness of the hardened and tempered pipe ends as compared to the pipe body.

All in all, the least possible amounts of accompanying elements, such as phosphorus (max. 0.0015% by weight) and nitrogen (max. 0.007% by weight) and low sulfur contents (max. 0.003% by weight) should be adjusted since they contribute to an excellent acid gas resistance.

A sufficient corrosion resistance of the pipeline, even when strongly corrosive media are conveyed, is ensured after an advantageous development of the invention by providing the pipe produced according to the invention with a corrosion-inhibiting layer before welding it together to give a pipe string. It can be e.g. a stainless steel pipe pushed into the initial pipe and connected thereto in firmly bonded or force-fit fashion. It is also conceivable that the inner surface of the initial pipe is provided with a corrosion-inhibiting layer by means of thermal spraying or by build-up welding.

Another advantage of the method according to the invention is to then produce the pipe ends with a reproducible geometry that corresponds to the customer requirements and that renders possible the welding-together without preceding measurement and assignment. The logistic effort for storage and transport of the pipes is minimized, which considerably reduces the costs. For this purpose, the pipes are mechanically processed in accordance with the required final sizes after the hardening and tempering step.

At the same time, the tolerances of the pipe end geometry are kept in very tight limits by the mechanical processing, which results in optimum welding conditions and renders possible an efficient production of the pipe connection, e.g. by automated welding methods. In addition, a high fatigue strength of the pipe connection is ensured due to large notch freedom on account of the small surface roughness.

What is favorable for an almost trouble-free flow of media in the subsequent connecting region of the pipes is in the longitudinal pipe direction a shoulder-free transition from the thickened pipe end to the non-thickened pipe region. According to an aspect of the invention, the largest possible radius or radii is/are provided for this purpose at the transition from the processed pipe end to the unprocessed pipe end. Correspondingly, a shoulder-free and notch-free transition from the thickened pipe end to the non-thickened pipe body is produced at the outer and/or inner circumference in a longitudinal pipe direction.

The wall thickening is advantageously chosen in such a way that the dimensional deviations existing on account of the pipe tolerances, in particular with respect to the roundness or ovality, can be compensated almost completely without falling below the nominal wall thickness as a result of the subsequent mechanical processing.

In order to guarantee a sufficient processing tolerance, it has thus proved to be favorable to provide a thickened wall portion of at least 3 mm, even better at least 10 mm, to the pipe outer side and/or to the pipe inner side over a length of at least 100 mm, proceeding from the front side of the pipe. Depending on the demand made on the dimensioning of the pipe cross-section in the region of the thickening, upsetting e.g. around 60 mm or more is also possible.

A thickening length proceeding from the front side of the pipe and having at least 150 mm, in some cases also 300 mm and more, has proved advantageous for ensuring a load-optimized welding seam region of the pipe ends.

If required, i.e. depending on the load requirements on the pipe ends, the thickened wall portion can, however, also be greater or smaller and extends over shorter or longer sections.

On the other hand, the thickened wall portion and the longitudinal extension thereof should be limited to an extent necessary for processing for reasons of production engineering.

Therefore, the thickened wall portion extends advantageously from the front side of the pipe in the longitudinal direction of the pipe over a length of at least 80 mm.

The thickened wall portion can be processed e.g. by boring, with a very small ovality and also very small diameter tolerances and highly reduced surface roughness being achievable.

If required, a centering ring protruding into the processed regions of the two pipe ends can be inserted before the pipe ends are welded together in order to ensure optimum alignment of the pipe ends for an automated welding operation.

The upsetting step is here made advantageously in such a way that the transitions to the pipe body, which are produced on the outer circumference and inner circumference during the upsetting operation are arranged so as to be displaced in relation to the longitudinal axis of the pipe. Comprehensive experiments have shown that this displaced arrangement of the transitions in the longitudinal axis of the pipe and the positioning of the radii in different cross-sectional planes of the pipes have a positive effect in the mechanical processing step on the fatigue strength of the connection in use.

For this purpose, these transitions are advantageously provided with the largest possible radius or with combinations of radii during the mechanical processing of the thickened wall portion. Due to their position in different cross-sectional planes they guarantee that the predetermined minimum wall thickness is observed and result in a smooth and notch-free transition to the non-thickened region of the pipe. As a result, a low stress concentration factor is advantageously ensured in the transition zone.

All in all, an excellent weldability at the pipe ends and mechanical properties meeting the deep-water requirements and the low temperature/ acid gas resistance of the entire pipe are achieved with only one alloying concept according to the method of the invention by using the material matched specifically with the upsetting and the subsequent heat treatment.

In addition, model pipe end tolerances of +/−0.25 mm for the inner diameter and +/−0.75 mm for the outer diameter are achieved by the mechanical processing, e.g. by removing, which results in an excellent accuracy of fit of the pipe ends to be welded together.

The model pipe end tolerances also lead to faster cycle times on the lay barges and reduce the repair weldings. Furthermore, pipes or pipelines produced in this way can be used in multifunctional fashion, i.e. from deep water applications for conveying highly corrosive media in reservoirs at high pressure and/or high temperatures via the use in environments with high fatigue stress.

Austenitizing temperatures between 910 and 980° C. with holding times between 10 and 30 minutes have proved to be favorable for the hardening and tempering step. Values between 610 and 680° C., advantageously between 640 and 670° C., with holding times between 10 and 45 minutes have proved of value as tempering temperatures. The cooling step is subsequently carried out in still air.

The pipe ends are hot-upsetted in an advantageous way via a predetermined length in one or more upsetting and reheating processes.

Wall thickness ratios of 1.5 to 2.5 of pipe ends to pipe body have shown favorable for the adjustment of the demanded material properties at the pipe ends and at the pipe body. It is important to observe this ratio because it is only in this way that the demanded properties can be achieved at the pipe ends and the pipe body in the hardening and tempering step.

As regards an excellent weldability of the pipe ends, a reduction in strength by at least 5%, more preferably at least 10%, below the strength of the intermediate pipe body is advantageously produced on account of the thickened wall portion in the hardening and tempering step.

The pipe ends are advantageously hot-upsetted over a predetermined length in one or more upsetting and reheating operations at temperatures between 1000 and 1450° C., the required pipe end cross-section being produced in the upsetted end region of the pipe by mechanical processing after the hardening and tempering step.

Although this method can be used in a particularly advantageous fashion for steels having minimum yield points of over 450 MPa, the application can also be favorable for steels below this limit, e.g. when a very good weldability must be achieved even under unfavorable welding conditions. Therefore, high-strength steels having a minimum yield point from 415 MPa are also taken into consideration according to the invention.

According to the invention, a seamless pipe consisting of a transformable steel having a minimum yield point of 415 MPa is produced by hot-rolling followed by hot-upsetting of the pipe ends for producing a thickened wall portion and a subsequent uniform hardening and tempering treatment of the entire pipe and subsequent mechanical processing of the thickened pipe ends to the demanded final dimensions with shoulder-free transitions to the intermediate pipe body, including a smaller yield point and strength at the thickened pipe ends as compared to the intermediate pipe body. According to the invention, this pipe has excellent fatigue, corrosion and welding properties.

This seamless pipe advantageously has a yield point and strength at the thickened pipe ends of at least 5%, preferably at least 10%, below the corresponding values of the pipe body.

This seamless pipe advantageously has the above described chemical composition in % by weight.

The pipes produced according to the above described method of the invention are advantageously used for producing pipelines, the pipe ends of the pipes being directly welded together. The term pipeline should be understood in this connection and in context with the invention in a very broad sense and comprises both the individual pipes and the pipe components necessary for the production of a pipeline, such as pipe bends, pipe turnouts, etc.

Further features, advantages and particulars of the invention follow from the below description of the described embodiments.

### BRIEF DESCRIPTION OF THE DRAWINGS

FIG. 1 shows a thickened wall portion at one pipe end, said thickened wall portion being produced by upsetting.

FIG. 2 shows a pipe end formation according to the invention in the processed condition,

FIG. 3 shows a schematic diagram of the dependence of the cooling rate on the pipe wall thickness when the pipe is hardened and tempered,

FIG. 4 shows a table on investigated alloys,

FIG. 5a shows a diagram on the hardness course across the pipe length,

FIG. 5b shows a diagram on the hardness course across wall cross-section at the pipe end,

FIG. 6a shows a diagram regarding the strength across the pipe length,

FIG. 6b shows a diagram regarding the strength at the pipe end,

FIG. 7a shows a diagram regarding the yield point ratio and regarding the stretching across the pipe length,

FIG. 7b shows a diagram regarding the yield point ratio and regarding the stretching at the pipe end,

FIG. 8a shows a diagram regarding the notched impact energy across the pipe length and

FIG. 8b shows a diagram regarding the notched impact energy at the pipe end.

### DESCRIPTION OF THE PREFERRED EMBODIMENTS

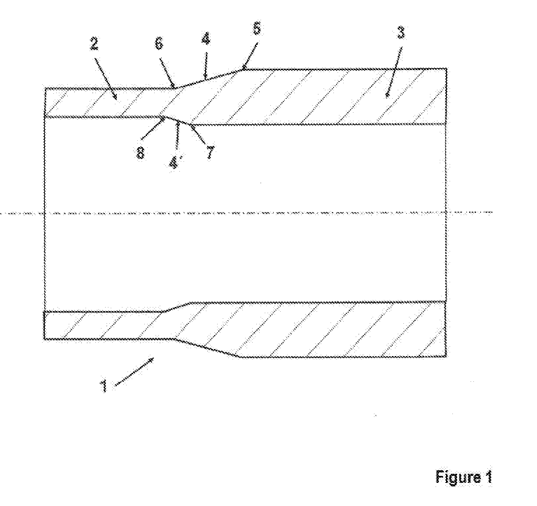

FIG. 1 shows a part of a pipe 1, which is produced according to the invention and has a thickened wall portion to the outer side and inner side of the pipe on at least one but preferably on both pipe ends 3, in a longitudinal section from the region of a transition between a pipe body 2 and a pipe end 3.

At the pipe end 3, the pipe 1 has a thickened wall portion which is produced by upsetting in a hot working step and which changes by means of a transitional region 4, 4 ′ into the outlet cross-section of the pipe body 2 of the pipe 1.

The thickened wall portion 3 is made in this example in such a way that the outer diameter of the pipe 1 is enlarged and the inner diameter is reduced. On the basis of the outlet cross-section of the pipe 1 and thus the cross-section of the non-upsetted pipe body 2, the wall thickness at the pipe end 3 is three times as large as the thickened wall portion of the outlet pipe. Therefore, the wall thickness ratio of upsetted pipe end 3 and the intermediate pipe body 2 is in this case 2.

According to an aspect of the invention, the upsetting process is here made in such a way that the transitional region 4 produced in the upsetting operation along the outer circumference and the transitional region 4′ produced on the inner circumference are arranged in a displaced fashion in relation to the longitudinal axis of the pipe.

The transitional region 4 produced by the upsetting operation has shoulders 5 and 6 arranged along the outer circumference of the pipe 1 in relation to the longitudinal axis of the pipe one after the other and at a distance from one another and the transitional region 4′ has shoulders 7 and 8 arranged along the inner circumference in relation to the longitudinal axis of the pipe one behind the other and at a distance from one another.

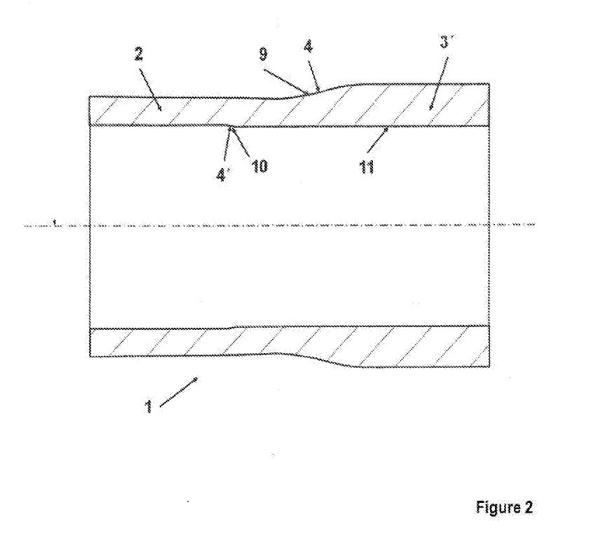

FIG. 2 shows the finished state of the pipe end 3 of the pipe 1, which is produced by mechanical processing, after the hardening and tempering step.

The finished contour of the mechanically processed pipe 1 has, at the pipe end 3′ of the pipe 1, a thickened wall portion which, on the one hand, complies with the demands made on the supporting cross-section after welding together the pipes 1, and, on the other hand, has a markedly reduced strength compared to the pipe body 2 due to the slower cooling in this thickened region in the hardening and tempering treatment with respect to an improved weldability.

The transitional region 4 is provided with a large radius 9, which ensures an extensive freedom from notches by a smooth, shoulder-free transition and a very small surface roughness in the processed region.

In order not to drop below a required minimum wall thickness of the pipe 1 in the area of the transitional region 4, the inner circumference of the thickened pipe end is not machined to the original inner diameter but a small thickened wall portion 11 is left, from where the transitional region 4′ is also provided with a large radius 10 which changes in a smooth and shoulder-free fashion into the outlet cross-section of the pipe 1 in the region of the pipe body 2.

According to the invention, radii 9 and 10 are positioned in different cross-sectional planes of the pipe, which has a positive effect on the fatigue strength of the connection in use.

Due to this arrangement, it is ensured, on the one hand, that the required minimum wall thickness is not reduced below a certain limit and, on the other hand, it is only in this way that a transition 4′ as notch-free as possible becomes the outlet cross-section of the pipe 1 in the region of the pipe body 2.

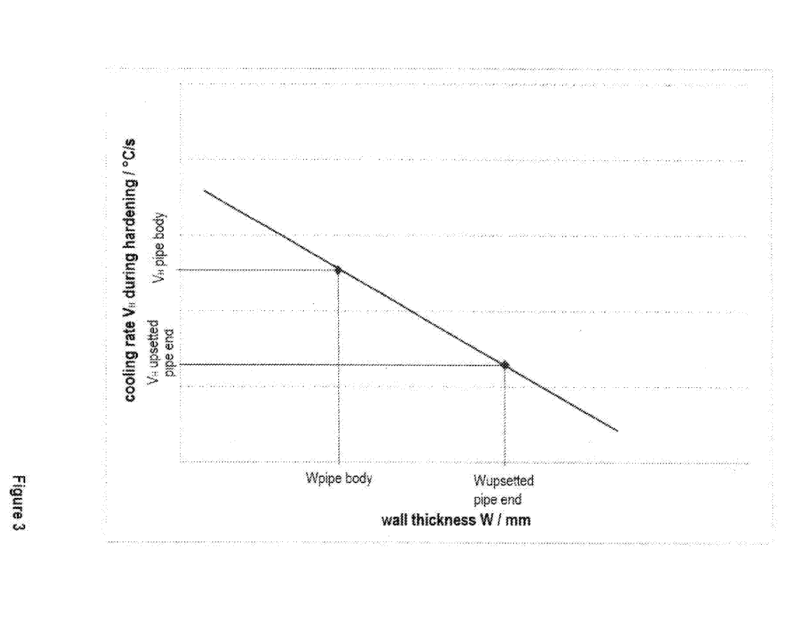

FIG. 3 shows by way of diagram the dependence of the cooling rate VH on the wall thickness W of the pipe 1 when a pipe 1 is hardened according to the invention.

As an example, a pipe 1 having grade X80 and an outlet wall thickness of 28.4 mm is upsetted to reach 57.4 mm and is subsequently hardened and tempered. Here, the pipes were subjected to a hardening and tempering treatment according to the invention accompanied by heating to the austenitizing temperature and subsequent quenching in water.

The cooling rate of the pipe body 2 and of the upsetted pipe ends 3 is subject to the wall thickness, the pipe body 2 having a higher cooling rate on account of the thinner wall than the thickened pipe ends. In the pipe body and the thickened end regions, the structure is predominantly bainitic according to the TTT diagram, with electron-microscopic differences in the grain size and deposition formation appearing which have an effect on the strength of the material after the hardening step.

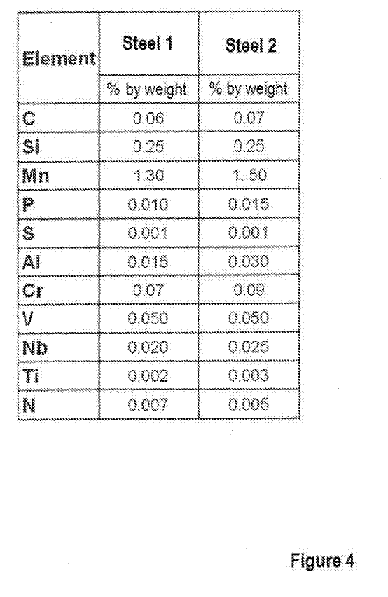

FIG. 4 shows a table of the investigated alloys.

The alloying composition of the steel 1 differs mainly from steel 2 by means of lowered contents of the elements carbon, manganese, aluminum, chromium, titanium and niobium in order to realize different strength classes of the outlet pipe. The contents of copper, nickel and molybdenum were varied within the ranges of 0.15 to 0.25% by weight for copper, 0.15 to 0.35% b weight for nickel and 0.08 to 0.35% by weight for molybdenum, the steel 1 always having lower contents of these elements.

The two steels were processed into seamless pipes 1 by hot rolling and the pipe ends 3 thereof were hot-upsetted to two times the initial wall thickness and the complete pipe 1 was subsequently hardened and tempered according to the invention, the indicated heat treatment parameters being adjusted for the upsetted pipe ends 3.

In the course of the heat treatment, the pipes 1 were initially uniformly heated to a temperature between 910 and 980° C. and, having reached the temperature also in the thickened pipe end, the temperature was maintained for 10 to 30 minutes. After this time, the pipes 1 were quenched to room temperature in a water bath.

In the subsequent tempering step, the pipes were heated to tempering temperatures of 610° C. to 680° C. and then maintained at this temperature for 15 to 45 minutes each. This was followed by a cooling step in still air.

Then, the mechanical-technological properties were determined by means of samples having different steel compositions and heat treatments.

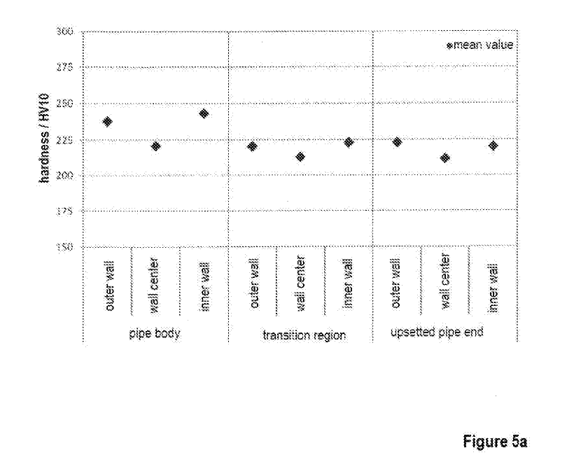

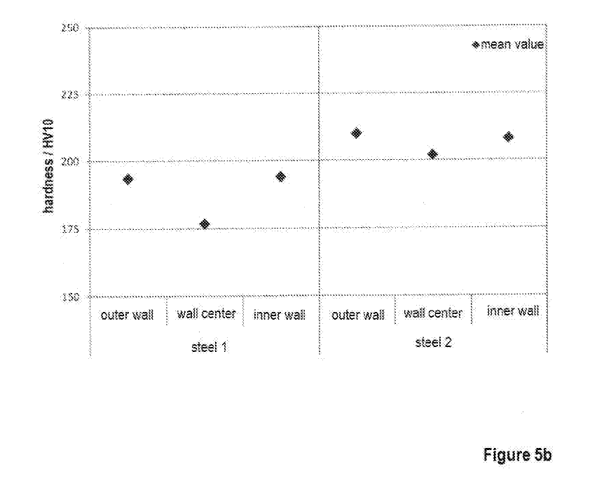

FIG. 5a shows in a diagram for the steel 2 the hardness course over the pipe length (pipe body 2, transitional region 4, upsetted pipe end 3) and wall cross-section (outer wall, wall center, inner wall).

FIG. 5b shows in a further diagram in comparison the hardness course for the investigated steels 1 and 2 by means of a thickened pipe end 3 across the wall cross-section.

The illustrated average values show that in the transitional region 4 and in the upsetted pipe end 3 lower hardness values are reached on the average as compared to the pipe body (FIG. 5a). A comparison of the steel alloys according to FIG. 5b shows that the higher-alloyed steel 2 serves to reach higher hardness values on the average as compared to steel 1, the wall thickness always having the lowest values.

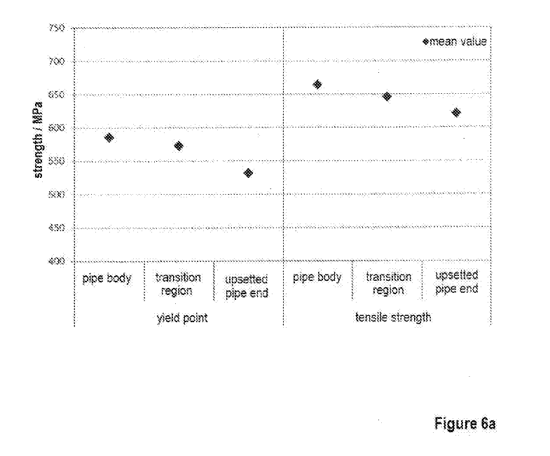

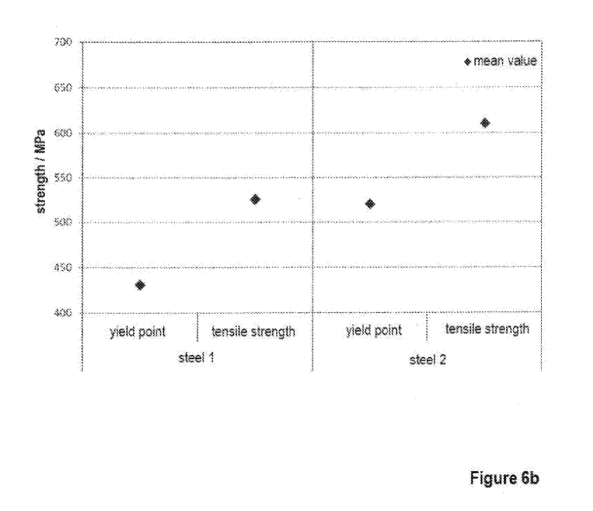

FIG. 6a shows in a diagram the course of yield point and tensile strength over the pipe length for steel 2 and FIG. 6b shows in a diagram the course of yield point and tensile strength depending on the employed steel on the thickened pipe end 3.

According to FIG. 6a it should be noted that yield point and tensile strength are reduced significantly from the pipe body 2 to the thickened pipe end 3, i.e. the objective according to the invention was achieved.

FIG. 6b shows in another diagram that at the thickened pipe end 3, the lowest values for yield point and strength were reached for the steel 1.

Therefore, the mechanical properties of the pipe end 3 can be adjusted in well-calculated fashion, depending on the requirement, via the steel composition or the heat treatment during the hardening and tempering treatment.

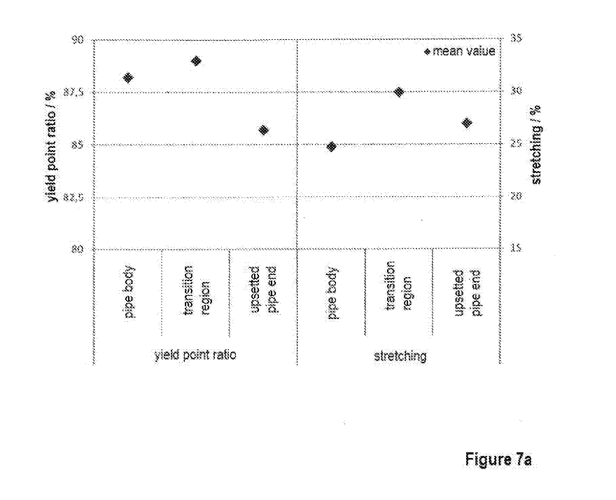

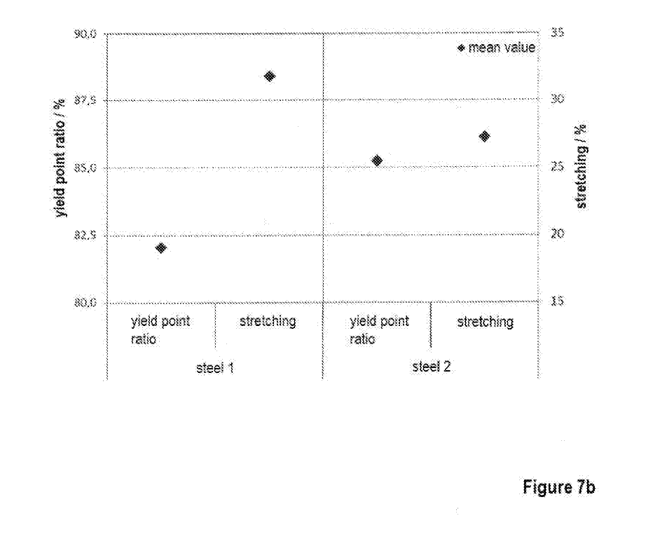

FIG. 7a shows in a diagram the yield point ratio and stretching across the pipe length also for steel 2 and FIG. 7b shows in a diagram the yield point ratio and the stretching by means of the thickened pipe end 3 for the steels 1 and 2.

It is also clear from these illustrations that the corresponding values of strength, yield point and thus the yield point ratio are markedly lower for the thickened pipe ends 3 and markedly higher for the stretching as compared to the pipe body 2 having the outlet wall thickness (FIG. 7a). According to expectations, steel 1 has altogether lower yield point ratios and higher stretching as compared to steel 2 (FIG. 7b).

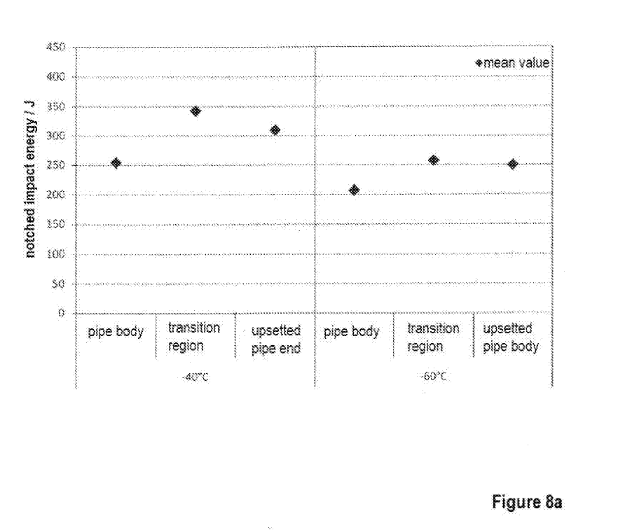

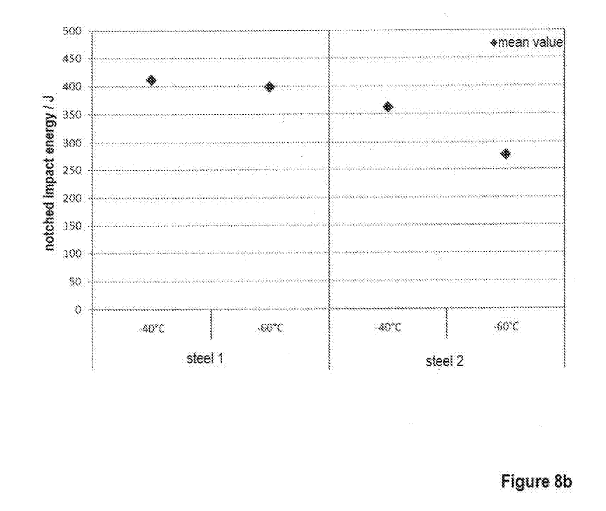

A similar picture is also shown in the diagrams for the notched impact energy across the pipe length for steel 2 (FIG. 8a) and on the thickened pipe end 3 for the investigated steels 1 and 2 (FIG. 8b). On the thickened pipe ends 3, a higher toughness is achieved on the average compared to the pipe body (FIG. 8a), values of 200 joules still being achieved on the pipe body and 250 joules being achieved on the thickened pipe end 3 also at −60° C.

According to the expectations, even higher values are achieved according to FIG. 8b for the steel 1 with about 400 joules at −60° C. as compared to steel 2.

All in all, it should be noted that a significant improvement of the processing properties could be achieved by lowering the strength and hardness as well as increasing the toughness with the wall thickness ratios adjusted according to the invention between the pipe body 2 and the pipe end 3 and the determined hardening and tempering parameters on the thickened pipe end 3.

### LIST OF REFERENCE SIGNS

1 pipe

2 pipe body

3 pipe end

4, 4 ′ transitional region

5, 6 shoulder transitional region outside

7, 8 shoulder transitional region inside

9 radius transitional region outside

10 radius transitional region inside

11 thickened wall portion inner side of the pipe

1. A method for producing hot-rolled, seamless pipes from transformable steel, for pipelines, the method comprising hot-upsetting pipe ends of pipes in order to achieve a thickened wall portion after a final rolling process of the pipes, and administering a uniform hardening and tempering treatment of the entire pipe following the hot-upsetting process, wherein a preselected ratio between a wall thickness of the pipe end and a wall thickness of a pipe body adjoining the pipe end is set by the hot-upsetting process such that the pipe end has a lower strength than the pipe body after the uniform hardening and tempering treatment of the entire pipe by using a previously ascertained wall thickness-dependent cooling rate during the hardening and tempering treatment.

2. The method according to claim 1, wherein a pipe with a pipe end is obtained after the uniform hardening and tempering treatment of the entire pipe after the hot-upsetting process, which has a lower strength, a lower hardness and a greater toughness as compared to the pipe body.

3. The method according to claim 1, wherein the hardening and tempering treatment comprises heating to a temperature between 910 and 980° C., a holding time at this temperature between 10 and 30 minutes, a subsequent quenching process and subsequent tempering to a temperature between 610 and 680° C., with holding times between 10 and 45 minutes followed by cooling in still air.

4. The method according to claim 1, wherein the step of hot-upsetting pipe ends comprises hot upsetting the pipe ends over a given length in one or more upsetting and reheating processes.

5. The method according to claim 1, wherein at least 1.1 times, 1.2 times or 1.3 times the wall thickness in relation to the wall thickness of the pipe body is produced at the pipe end by the hot-upsetting process.

6. The method according to claim 1, wherein at least two times the wall thickness in relation to the wall thickness of the pipe body is produced at the pipe end by the hot-upsetting process.

7. The method according to claim 1, wherein at least 1.5 times and at most 2.5 times the wall thickness in relation to the wall thickness of the pipe body is produced at the pipe end by the hot-upsetting process.

8. The method according to claim 1, wherein the thickened wall portion extends from a front side of the pipe in the longitudinal direction of the pipe over a length of at least 80 mm.

9. The method according to claim 1, further comprising processing the pipes mechanically in accordance with the required finished sizes after the hardening and tempering step.

10. The method according to claim 9, wherein a shoulder-free and notch-free transition is produced from the thickened pipe end to the non-thickened pipe body in the longitudinal direction of the pipe on the outer circumference and/or inner circumference.

11. The method according to claim 1, wherein a strength is produced at the pipe ends, which is at least 5% below the strength of the pipe body.

12. The method according to claim 1, wherein the pipe ends are upsetted in the step of hot-upsetting at temperatures between 1000 and 1450° C.

13. The method according to claim 1, wherein high-strength steel with a minimum yield point of 415 MPa is used.

14. The method according to claim 1, wherein transformable steel with the following chemical composition in percent by weight is used as a material for the pipe production:
C: max. 0.18
Si: max. 0.45
Mn: max. 1.85
P: max. 0.02
S: max. 0.015
N: max. 0.012
Cr: max. 0.30
Cu: max. 0.50
Ti: max. 0.04
As: max. 0.030
Sn: max. 0.020
Nb+V+Ti: max. 0.15%
Mo: max. 0.50%
Ni: max. 0.50%
Pcm: max. 0.22% for C contents of less than or equal to 0.12% with
Pcm=C+Si/30+(Mn+Cu+Cr)/20+Ni/60+Mo/15+V/10+5 B and
CE: max. 0.47 for C contents above 0.12% and
CE: max. 0.22 for C contents of up to 0.12% with
CE=C+Mn/6+(Cr+Mo+V)/5+(Cu+Ni)/15
the remainder being iron including unavoidable steel accompanying elements.

15. The method according to claim 14, wherein transformable steel with the following chemical composition in percent by weight is used as a material for the pipe production:
C: 0.05 to 0.12
Si: 0.20 to 0.40
Mn: 1.35 to 1.75
P: max. 0.015
S: mx. 0.003
N: max. 0.007
Cr: max. 0.10
Al: 0.020 to 0.040
Mo: 0.08 to 0.35
Ni: 0.15 to 0.35
Cu: 0.15 to 0.25
Nb: 0.02 to 0.08
V: 0.05 to 0.08
B: max. 0.0005 with
Pcm max. 0.21
the remainder being iron, including unavoidable steel-accompanying elements.

16. The method according to claim 14, wherein the following values for Pcm and CE are observed depending on the demanded minimum yield point of the employed material:
415 to 485 MPa: Pcm max. 0.21 and CE max. 0.38
485 to 555 MPa: Pcm max. 0.22 and CE max. 0.47
625 to 690 MPa: Pcm max. 0.25 and CE max. 0.53.

17. A seamless pipe made from a transformable steel with a minimum yield point of 415 MPa produced by hot-rolling, followed by hot-upsetting of a pipe end of the pipe for producing a thickened wall portion comprising a thickened pipe end, subsequent uniform hardening and tempering treatment of the entire pipe and subsequent mechanical processing of the thickened pipe end to the demanded final size, wherein the pipe comprises shoulder-free transitions to the intermediate pipe body, and wherein the thickened pipe end comprises a lower yield point and strength as compared to the intermediate pipe body.

18. The seamless pipe according to claim 17, wherein the yield point and the strength at the thickened pipe ends is at least 5% below the corresponding values of the pipe body.

19. The seamless pipe according to claim 17, wherein the pipe consists of transformable steel having the following chemical composition in % by weight:
C: max. 0.18
Si: max. 0.45
Mn: max. 1.85
P: max. 0.02
S: max. 0.015
N: max. 0.012
Cr: max. 0.30
Cu: max. 0.50
Ti: max. 0.04
As: max. 0.030
Sn: max. 0.020
Nb+V+Ti: max. 0.15%
Mo: max. 0.50%
Ni: max. 0.50%
Pcm: max. 0.22% for C contents of less than or equal to 0.12% with
Pcm=C+Si/30+(Mn+Cu+Cr)/20+Ni/60+Mo/15+V/10+5 B and
CE: max. 0.47 for C contents above 0.12% and
CE: max. 0.22 for C contents of up to 0.12% with
CE=C+Mn/6+(Cr+Mo+V)/5+(Cu+Ni)/15
the remainder being iron including unavoidable steel accompanying elements.

20. The seamless pipe according to claim 17, wherein the pipe consists of transformable steel with the following chemical composition in % by weight:
C: 0.05 to 0.12
Si: 0.20 to 0.40
Mn: 1.35 to 1.75
P: max. 0.015
S: mx. 0.003
N: max. 0.007
Cr: max. 0.10
Al: 0.020 to 0.040
Mo: 0.08 to 0.35
Ni: 0.15 to 0.35
Cu: 0.15 to 0.25
Nb: 0.02 to 0.08
V: 0.05 to 0.08
B: max. 0.0005 with
Pcm max. 0.21
the remainder being iron, including unavoidable steel-accompanying elements.

21. Use of pipes produced according to the method of claim 1 for producing pipelines, wherein the pipe ends of the pipes are welded together.

22. The method according to claim 3, wherein the subsequent tempering comprises tempering to a temperature between 640 and 670° C.

23. The method according to claim 11, wherein a strength is produced at the pipe ens which is at least 10% below the strength of the pipe body.

24. The seamless pipe according to claim 18, wherein the yield point and the strength at the thickened pipe ends is at least 10% below the corresponding values of the pipe body.
